(19) United States
(12) Patent Application Publication
(10) Pub. No.: US 2014/0109016 A1
(43) Pub. Date: Apr. 17, 2014

(54) GESTURE-BASED CURSOR CONTROL

(71) Applicants: Yu Ouyang, San Jose, CA (US); Shumin Zhai, Los Altos, CA (US)

(72) Inventors: Yu Ouyang, San Jose, CA (US); Shumin Zhai, Los Altos, CA (US)

(21) Appl. No.: 13/735,869

(22) Filed: Jan. 7, 2013

Related U.S. Application Data
(60) Provisional application No. 61/714,617, filed on Oct. 16, 2012.

(51) Int. Cl. G06F 3/0481

(52) U.S. Cl. CPC G06F 3/04812
USPC 715/856

(57) ABSTRACT

In general, this disclosure describes techniques for enabling gesture-based cursor control on gesture keyboards. For example, a computing device outputs a graphical keyboard and a text display region, including a cursor at a first cursor location. The computing device detects a gesture that originates at a location of the graphical keyboard and determines whether the location of the detected gesture originates within a cursor control region of the graphical keyboard. In response to determining that the location of the detected gesture is within the cursor control region, the computing device also outputs the cursor at a second cursor location that is different from the first cursor location, wherein the second cursor location is based at least in part on the gesture.

### CROSS-REFERENCE TO RELATED APPLICATIONS

This application claims the benefit of U.S. Provisional Application No. 61/714,617, filed Oct. 16, 2012, the entire content of which is incorporated herein in its entirety.

### BACKGROUND

Computing devices (e.g., mobile phones, tablet computers, etc.) may provide a graphical keyboard as part of a graphical user interface for composing text using a presence-sensitive screen. The graphical keyboard may enable a user of the computing device to enter text (e.g., an e-mail, a text message, or a document, etc.). For instance, a presence-sensitive display of a computing device may output a graphical, or soft, keyboard that permits the user to enter data by tapping keys displayed at the presence-sensitive display.

Graphical keyboards allowing for interaction through tapping or swiping may be used to input text into a smartphone using one or more gestures to select keys. Such keyboards may suffer from limitations in accuracy, speed, and inability to adapt to the user. For example, text entry through tapping or swiping, in order to select one or more characters, can be inaccurate and error-prone. Manual correction or editing of text entered on portable computing devices may affect speed and efficiency of text entry. For example, a presence-sensitive display of a computing device may display a body of text that requires editing. The presence-sensitive display may enable a user to select a location at which they wish to place a cursor within the body of text when performing a manual correction or edit. However, the user may experience difficulty editing the text when input controls and text displays are small in size relative to the input medium of a user (e.g., relative to the size of the user's fingers).

### SUMMARY

In one example, a method includes outputting, by a computing device and for display at a presence-sensitive display, a graphical user interface that includes a graphical keyboard comprising a cursor control region and a non-cursor control region, wherein the cursor control region does not overlap with the non-cursor control region and a text display region that includes a cursor at a first cursor location of the text display region. The method may also include detecting, by the computing device, an indication of a gesture received at the presence-sensitive display, the gesture originating at a location of the graphical keyboard, and determining, by the computing device, whether the location of the detected gesture is within the cursor control region of the graphical keyboard. The method may further include, in response to determining that the location of the detected gesture is within the cursor control region, outputting, for display at the presence-sensitive display, the cursor at a second cursor location of the text display region that is different from the first cursor location, wherein the second cursor location is based at least in part on the gesture.

In one example, a computer-readable medium is encoded with instructions that, when executed, cause one or more processors of a computing device to perform operations including outputting, for display at a presence-sensitive display, a graphical user interface that comprises a graphical keyboard comprising a cursor control region and a non-cursor control region, wherein the cursor control region does not overlap with the non-cursor control region and a text display region that includes a cursor at a first cursor location of the text display region. The computer-readable storage medium may be further encoded with instructions that, when executed, cause one or more processors of a computing device to perform operations including detecting an indication of a gesture received at the presence-sensitive display, the gesture originating at a location of the graphical keyboard, and determining, by the computing device, whether the location of the detected gesture is within the cursor control region of the graphical keyboard. The computer-readable storage medium may be further encoded with instructions that, when executed, cause one or more processors of a computing device to perform operations including, in response to determining that the location of the detected gesture is within the cursor control region, outputting, for display at the presence-sensitive display, the cursor at a second cursor location of the text display region that is different from the first cursor location, wherein the second cursor location is based at least in part on the gesture.

In one example, a computing device includes an input device, an output device, and one or more processors. The computing device may also include a memory storing instructions that when executed by the one or more processors cause the one or more processors to output, for display at the output device, a graphical user interface that comprises a graphical keyboard comprising a cursor control region and a non-cursor control region, wherein the cursor control region does not overlap with the non-cursor control region and a text display region that includes a cursor at a first cursor location of the text display region. The one or more processors may also be configured to detect an indication of a gesture received at the input device, the gesture originating at a location of the graphical keyboard, and determine whether the location of the detected gesture is within the cursor control region of the graphical keyboard. The one or more processors may further be configured to, in response to determining that the location of the detected gesture is within the cursor control region, output, for display at the output device, the cursor at a second cursor location of the text display region that is different from the first cursor location, wherein the second cursor location is based at least in part on the gesture.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computing device and graphical user interfaces (GUIs) for providing gesture-based cursor control, in accordance with one or more aspects of the present disclosure.

FIG. 2 is a block diagram illustrating further details of one example of a computing device shown in FIG. 1 for providing gesture-based cursor control, in accordance with one or more aspects of the present disclosure.

FIG. 3 is a block diagram illustrating an example computing device and a GUI for providing gesture-based cursor control, in accordance with one or more aspects of the present disclosure.

FIGS. 4A, 4B are block diagrams illustrating an example computing device and a GUI for providing gesture-based cursor control, in accordance with one or more aspects of the present disclosure.

FIG. 5 is a block diagram illustrating an example computing device and a GUI for providing gesture-based cursor control, in accordance with one or more aspects of the present disclosure.

FIG. 6 is a flow diagram illustrating example operations that may be used to provide gesture-based cursor control, in accordance with one or more aspects of the present disclosure.

### DETAILED DESCRIPTION

In general, example techniques of this disclosure are directed to improving cursor control within a body of text. Such techniques may ease the process of modifying text displayed at a presence-sensitive display of a computing device. Techniques of the present disclosure may reduce the user effort required to perform precise relocation of a cursor, and increase the accurate selection of text. For instance, techniques of the disclosure may improve a user's ability to select displayed text that is smaller than a user's input unit (e.g., the user's finger). Example techniques of the disclosure may reduce user effort to relocate the cursor and may therefore reduce diversion of the user's focus from a graphical keyboard of the GUI. Consequently techniques of the disclosure may improve concentration and, ultimately, speed of text entry.

In one aspect of this disclosure, a cursor navigation and text manipulation mechanism may employ a virtual tracking surface in a dedicated region on the software keyboard. The cursor control region can be implemented unobtrusively on top of an existing area of the standard keyboard layout. In one example the initial cursor control region may be the area of the presence-sensitive display that displays the spacebar of a graphical keyboard. When the user performs a touch gesture at the cursor control region (e.g., slides left or right on top of this region) the computing device may cause the cursor to move in the corresponding direction.

In some examples, a gesture classifier included in the computing device may distinguish between different possible interactions within the cursor control region (e.g. cursor sliding movement, spacebar tap, spacebar long-press, etc.). Once cursor control is initiated by a gesture, the cursor may track the finger position along the spacebar in real-time, allowing fine-grained control. Providing further functionality, a user may hold down a mode key (e.g., the key to the left of the spacebar) to enable a selection mode. In the selection mode, the cursor control region may be operable to select text. Once text has been selected, the user may use simple one-key shortcuts for text editing while the mode key is pressed.

In another aspect of this disclosure, the user may also provide an indication that causes the presence-sensitive display to output an enlarged cursor control region, allowing more advanced 2-dimensional and multi-touch gestures. The enlarged cursor control region may remain displayed in place so a user can use the cursor control region like a virtual “trackpad,” lifting his or her finger freely to make multiple scrolling movements. The enlarged cursor control region may also provide access to more types of interaction such as 2-dimensional scrolling, without sacrificing keyboard display area. One or more virtual buttons on the left or right may simulate behavior analogous to the left and/or right mouse clicks of a desktop computer.

By leveraging a virtual tracking surface, a computing device may enable a user to improve the ease and speed of text editing on the computing device (without distracting the user from the graphical keyboard during the process). Additionally, the computing device may provide functionality for an enlarged cursor control region and cursor control buttons to allow the user more precise cursor control and editing abilities. Techniques of this disclosure may decrease user effort associated with text selection or cursor placement (e.g., “fat finger” difficulties). Moreover, by implementing the cursor control region over the existing graphical keyboard, the region may not conflict with current gesture keyboards while using an existing region of the keyboard.

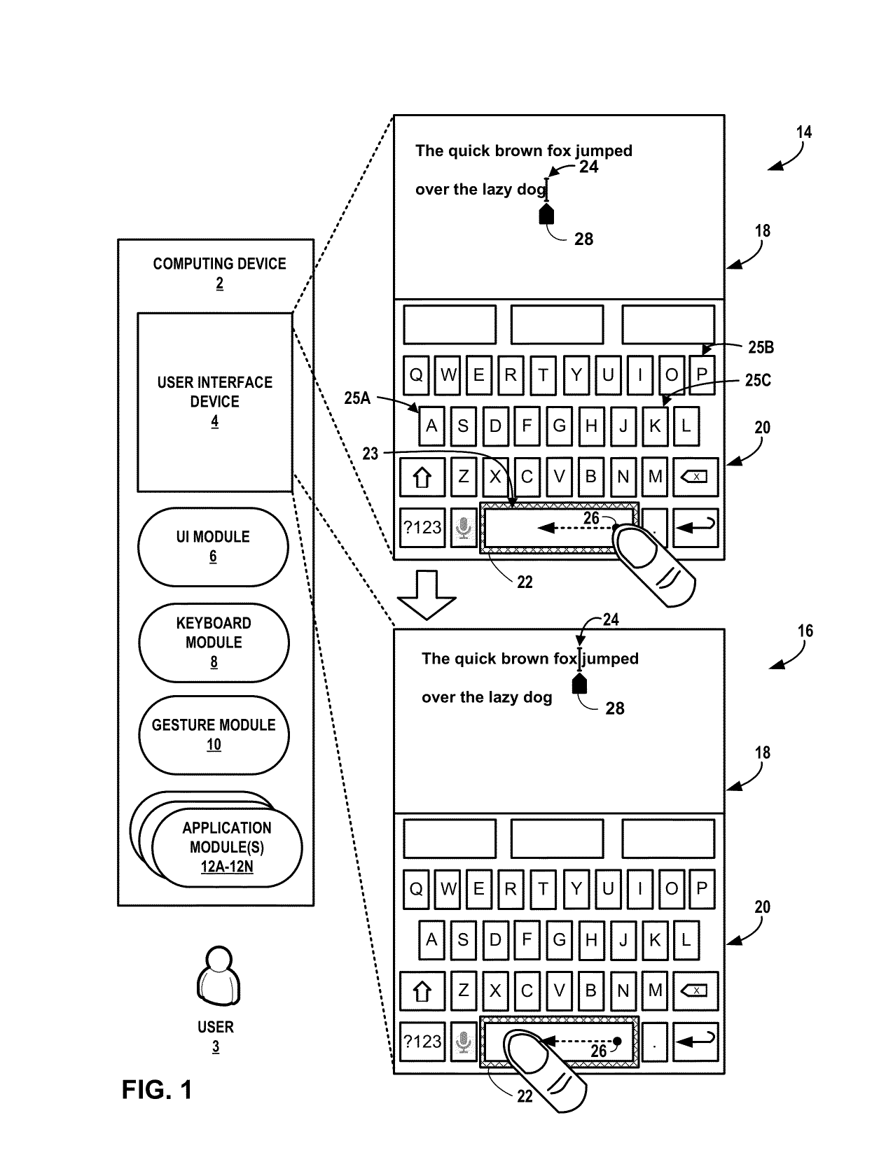

FIG. 1 is a block diagram illustrating an example computing device 2 and graphical user interfaces (GUIs) for providing gesture-based cursor control, in accordance with one or more aspects of the present disclosure. In some examples, computing device 2 may be associated with user 3. A user associated with a computing device may interact with the computing device by providing various user inputs to the computing device. In some examples, user 3 may have one or more accounts with one or more services, such as a social networking service and/or a telephone service, and the accounts may be registered with computing device 2, which is associated with user 3.

Examples of computing device 2 may include, but are not limited to, portable or mobile devices such as mobile computing devices, mobile phones (including smartphones), laptop computers, desktop computers, tablet computers, smart television platforms, personal digital assistants (PDAs), servers, mainframes, etc. As shown in the example of FIG. 1, computing device 2 may be a mobile computing device (e.g., smartphone, tablet computer, etc.). Computing device 2, in some examples, can include a user interface (UI) device 4, user interface (UI) device module 6, keyboard module 8, gesture module 10, and application modules 12A-12N (hereinafter “application modules 12”). Other examples of a computing device 2 that implement techniques of this disclosure may include additional components not shown in FIG. 1, or may include less than those components of computing device 2 as shown.

Computing device 2 may include UI device 4. In some examples, UI device 4 is configured to receive tactile, audio, or visual input. Examples of UI device 4, as shown in FIG. 1, may include a touch-sensitive and/or presence-sensitive display or any other type of device for receiving input. UI device 4 may output content such as GUI 14 and GUI 16 for display. In the example of FIG. 1, UI device 4 may be a presence-sensitive display that can display a graphical user interface and receive input from a user (e.g., user 3) using capacitive or inductive detection at or near the presence-sensitive display.

As shown in FIG. 1, computing device 2 may include UI module 6. UI module 6 may perform one or more functions to receive input, such as user input from UI device 4 or network data, and send such input to other components associated with computing device 2, such as keyboard module 8, gesture module 10, or application modules 12. UI module 6 may determine other components to which to send such input based upon what type of input is determined by UI module 6. As one example, UI module 6 may receive input data from UI device 4, determine that the input constitutes a gesture, and send such input data to gesture module 10. In other examples, UI module 6 may determine that the input data constitutes another type of input, and send the input data to keyboard module 8 or application modules 12. UI module 6 may also receive data from components associated with computing device 2, such as application modules 12. Using the data, UI module 6 may cause other components associated with computing device 2, such as UI device 4, to provide output based on the data. For instance, UI module 6 may receive data from one of application modules 12 that causes UI device 4 to display GUIs 14 and 16.

Computing device 2, in some examples, includes keyboard module 8. Keyboard module 8 may include functionality to receive and/or process input data received at a graphical keyboard. For example, keyboard module 8 may receive data (e.g., indications) representing inputs of certain keystrokes, gestures, etc., from UI module 6 that were inputted by user 3 as tap gestures and/or continuous swiping gestures at UI device 4 via a displayed graphical keyboard. Keyboard module 8 may process the received keystrokes to determine intended characters, character strings, words, phrases, etc., based on received input locations, input duration, or other suitable factors. Keyboard module 8 may also function to send character, word, and/or character string data to other components associated with computing device 2, such as application modules 12. That is, keyboard module 8 may, in various examples, receive raw input data from UI module 6, process the raw input data to obtain text data, and provide the data to application modules 12. For instance, a user (e.g., user 3) may perform a swipe gesture at a presence-sensitive display of computing device 2 (e.g., UI device 4). When performing the swipe gesture, user 3's finger may continuously traverse over or near one or more keys of a graphical keyboard displayed at UI device 4 without user 3 removing her finger from detection at UI device 4. UI module 6 may receive an indication of the gesture and determine user 3's intended keystrokes from the swipe gesture. UI module 6 may then provide one or more locations or keystrokes associated with the detected gesture to keyboard module 8. Keyboard module 8 may interpret the received locations or keystrokes as text input, and provide the text input to one or more components associated with computing device 2 (e.g., one of application modules 12).

As shown in FIG. 1, computing device 2 may also include gesture module 10. In some examples, gesture module 10 may be configured to receive gesture data from UI module 6 and process the gesture data. For instance, gesture module 10 may receive data indicating a gesture input by a user (e.g., user 3) at UI device 4. Gesture module 10 may determine that the input gesture corresponds to a typing gesture, a cursor movement gesture, a cursor area gesture, or other gesture. In some examples, gesture module 10 determines one or more alignment points that correspond to locations of UI device 4 that are touched or otherwise detected in response to a user gesture. In some examples, gesture module 10 can determine one or more features associated with a gesture, such as the Euclidean distance between two alignment points, the length of a gesture path, the direction of a gesture, the curvature of a gesture path, the shape of the gesture, and maximum curvature of a gesture between alignment points, speed of the gesture, etc. Gesture module 10 may send processed data to other components associated with computing device 2, such as application modules 12.

Computing device 2, in some examples, includes one or more application modules 12. Application modules 12 may include functionality to perform any variety of operations on computing device 2. For instance, application modules 12 may include a word processor, a spreadsheet application, a web browser, a multimedia player, a server application, a video editing application, a web development application, etc. As described in the example of FIG. 1, one of application modules 12 (e.g., application module 12A) may include functionality of an email client application that provides data to UI module 6, causing UI device 4 to output GUIs 14, 16. Application module 12A may further include functionality to enable user 3 to input and modify text content by performing tap gestures or continuous swipe gestures at UI device 4 (e.g., on a displayed graphical keyboard). For example, application module 12A may cause UI device 4 to display graphical keyboard 20 and text display region 18. In response to receiving user input through use of graphical keyboard 20, application module 12A may create and/or modify text content in GUIs 14, 16.

Techniques of this disclosure provide a mechanism for precise cursor control and text selection using gestures that originate within a cursor control region of a graphical keyboard. For example, a graphical keyboard displayed at a presence-sensitive display of a computing device may have a spacebar that is designated as the cursor control region. After inputting text via the graphical keyboard, a user of the computing device may initiate a touch of the spacebar and then slide his or her finger to the left. This gesture may cause the cursor, originally positioned in front of the inputted text, to scroll to the left, through the inputted text. The speed of the cursor's movement may be proportional to the speed of the user's finger on the presence-sensitive display. The user may use another finger to press and hold on a mode button of the graphical keyboard, thereby causing the cursor to select that text which it passes. Upon the user's release of the mode button and the gesture, the user may immediately resume use of the graphical keyboard in normal fashion. Other techniques of this disclosure may provide users with the ability to use an enlarged cursor control region for two-dimensional text navigation and enable display of cursor control buttons. The example techniques of the disclosure are further described below with respect to FIG. 1.

As shown in FIG. 1, GUIs 14, 16 may be user interfaces generated by one of application modules 12 that allow a user (e.g., user 3) to interact with computing device 2. GUIs 14, 16 may include graphical keyboard 20 and/or text display region 18. Text display region 18 may include text content and/or cursor 24. Examples of text content may include letters, words, numbers, punctuation marks, images, icons, a group of moving images, etc. Such examples may include a picture, hyperlink, icons, characters of a character set, etc. Cursor 24 may indicate a position at which presently entered text content would be inputted. In some examples, the cursor may be a line, an arrow, a symbol, a highlighted character, etc. In other words, the cursor may consist of any means of indicating a position within text content. As shown in FIG. 1, text display region 18 may display text content entered by user 3. For purposes of illustration in FIG. 1, text content may include “The quick brown fox jumped over the lazy dog”. UI module 6 may cause UI device 4 to display text display region 18 with the included text content and cursor 24.

Graphical keyboard 20 may be displayed by UI device 4 as an ordered set of selectable keys. Keys may represent a single character from a character set (e.g., letters of the English alphabet), or may represent combinations of characters. One example of a graphical keyboard may include a traditional “QWERTY” keyboard layout. Other examples may contain characters for different languages, different character sets, or different character layouts. As shown in the example of FIG. 1, graphical keyboard 20 includes a version of the traditional “QWERTY” keyboard layout for the English language providing character keys as well as various keys (e.g., the “?123” key) enabling other functionality. Graphical keyboard 20 includes keys 25A, 25B, and 25C, allowing for user input of an “A”, “P”, or “K” character, respectively. As shown in the example of FIG. 1, graphical keyboard 20 may also include spacebar key 23. Spacebar key 23 may provide functionality to input a space character. In accordance with various aspects of this disclosure, graphical keyboard 20 may include cursor control region 22. Cursor control region 22 may be attached to or otherwise share a location with spacebar key 23 of graphical keyboard 20. Areas of graphical keyboard 20 not included in cursor control region 22 may be referred to as a non-cursor control region. In some examples, cursor control region 22 and the non-cursor control region may be mutually exclusive of each other. That is, cursor control region 22 and the non-cursor control region may not overlap at all. In other examples, cursor control region 22 and the non-cursor control region may share some degree of overlap.

Cursor control region 22 may be a visually designated area such as a dedicated portion of a graphical keyboard. For instance, colors, borders, shading, or other such graphical effects may indicate the visually designated area. In other examples, cursor control region 22 may be visually indistinguishable from the non-cursor control region. In some examples, user 3 may initially determine the cursor control region by providing, as input, an area of UI device 4. In other examples, UI module 6 may include a default cursor control region if none is supplied by user 3. That is, the cursor control region may or may not be user-defined. In the example of FIG. 1, cursor control region 22 is indistinguishable from graphical keyboard 20, occupying the same designated area as spacebar key 23. That is, cursor control region 22 is displayed in FIG. 1 for purposes of visually illustrating the region, but cursor control region 22 may not be displayed graphically in GUI 14. The display area within spacebar key 23 of graphical keyboard 20, as displayed at UI device 4 constitutes cursor control region 22. The display area not within spacebar key 23 constitutes the non-cursor control region. In other examples, cursor control region 22 may consist of an area of a presence-sensitive display, a key on a displayed graphical keyboard, a group of keys, a line, or any other designated region.

As shown in the example of FIG. 1, application module 12A may cause UI device 4 to display GUI 14. GUI 14 may initially include graphical keyboard 20, and text display region 18 containing text content and cursor 24. Consequently, application module 12A may cause UI device 4 to display cursor 24 at a first cursor location with respect to the displayed text content. That is, as shown in the example of GUI 14 of FIG. 1, cursor 24 may be located to the right of the “g” character in the word “dog.”

UI device 4 may receive input from user 3 in the form of a gesture. In one example, the gesture may be a tap gesture in which user 3's finger moves into proximity with UI device 4 such that the finger is temporarily detected by UI device 4 and then user 3's finger moves away from UI device 4 such that the finger is no longer detected. In a different example, user 3 may perform a swipe gesture by moving his or her finger into proximity with UI device 4 such that the finger is detected by UI device 4. In this example, user 3 may maintain his or her finger in proximity to UI device 4 to perform subsequent motions before removing the finger from proximity to UI device 4 such that the finger is no longer detectable.

User 3 may desire to move cursor 24 of text display region 18 to a second cursor location within the displayed text content. That is, user 3 may desire to move cursor 24 to a location other than the one in which it presently exists, i.e., the first cursor location. In some examples, the second cursor location may be a location to the left, or the right of the first cursor location, or on a line of text above or below the line of text on which the first cursor location is located. In any case, user 3, in accordance with techniques of the disclosure, may perform a gesture originating within cursor control region 22 of graphical keyboard 20. As shown in FIG. 1, user 3 may perform gesture 26 to relocate cursor 24 without taking his or her focus off of graphical keyboard 20 and without obscuring text content with a finger.

When user 3 performs gesture 26, UI module 6 may receive an indication of a gesture detected as originating at a third location of the presence-sensitive display. As shown in the example of FIG. 1, the third location may be within cursor control region 22. In some examples, the gesture may constitute a tap gesture. UI module 6 may then send an indication of this gesture to keyboard module 8. In other examples, the gesture may constitute another type of gesture, such as a continuous swipe gesture, and UI module 6 may send an indication to gesture module 10. As shown in FIG. 1 as one example of a non-tap gesture, gesture 26 may constitute a left-slide gesture. In this case, UI module 6 may send an indication of gesture 26 to gesture module 10.

UI module 6 may receive an indication of gesture 26 and provide a location of gesture 26 to gesture module 10. In some examples, if gesture module 10 determines that gesture 26 did not originate within cursor control region 22, gesture module 10 may ignore gesture 26, or perform some other action not related to controlling the location of cursor 24 (e.g., input a sequence of characters or change functionality). If, however, gesture module 10 determines that gesture 26 did originate within cursor control region 22, gesture module 10 may interpret gesture 26 as a cursor control gesture. That is, gestures performed at cursor control region 22 may cause the cursor to move to a different location, while gestures performed at a non-cursor control region that is different from cursor control region 22 may not cause the cursor to move to a different location.

Gesture module 10 may then send an indication of gesture 26 to other components associated with computing device 2, such as UI module 6 and/or one or more of application modules 12. As shown in FIG. 1, gesture 26 may originate within cursor control region 22. Consequently, UI module 6 may, in response to receiving an indication of gesture 26 from gesture module 10, cause UI device 4 to visually indicate the received input by displaying cursor indicator 28. In some examples, UI module 6 may not display cursor indicator 28. Cursor indicator 28 may assist user 3 in locating cursor 24 during input of a cursor control gesture (e.g., gesture 26). In some examples, cursor indicator 28 may be a shape, object, image, etc. located directly below cursor 24. In other examples, cursor indicator 28 may be a color highlighting cursor 24, or other means of emphasizing or otherwise calling attention to the location of cursor 24.

Responsive to receiving an indication of gesture 26 from gesture module 10, UI module 6 may also cause UI device 4 to display cursor 24 and/or cursor indicator 28 at a second cursor location in text content displayed in text display region 18. As shown in FIG. 1, UI 6 module causes UI device 4 to display cursor 24 and cursor indicator 28 at a second cursor location within the text content displayed in text display region 18. That is, as shown in GUI 16, cursor 24 may be displayed by UI device 4 to the left of the “j” character in the word “jumped,” contained in the text content displayed in text display region 18. In the current example, user 3 may subsequently remove his or her finger from the presence-sensitive display such that the finger is no longer detectable by UI device 4 (e.g., ending gesture 26). In other examples, user 3 may maintain his or her finger, and the finger may remain detectable by UI device 4.

In some examples, responsive to receiving an indication of a cursor control gesture, UI module 6 may cause UI device 4 to display cursor 24 and cursor indicator 28 in consecutive locations based at least in part upon the input cursor control gesture. That is, UI device 4 may display cursor 24 and cursor indicator 28 as “scrolling” through the text content displayed in text display region 18. In other examples, UI device 4 may simply display cursor 24 and cursor indicator 28 at a second cursor location within the text content, based at least in part upon the input cursor control gesture. In the example of FIG. 1, upon receiving the displayed gesture 26 in GUI 14, UI module 6 may cause UI device 4 to display cursor 24 and cursor indicator 28 at numerous locations, consecutively to the left of the previous location, before displaying cursor 24 and cursor indicator 28 at the second cursor location, as shown in GUI 16. For instance, during receipt of gesture 26 moving cursor 24 to the left as shown in FIG. 1, cursor 24 may have been displayed by UI device 4, temporarily, between every character, between every 3 characters, between words, etc. At each displayed location of cursor 24, cursor indicator 28 may similarly have been displayed underneath cursor 24 by UI device 4.

In some examples, the number of characters traversed by cursor 24 as a result of user 3's input of gesture 26 (e.g., the number of characters between the first and second positions of cursor 24) may be proportional to the distance user 3's finger moved during the duration of gesture 26. If user 3's finger moved a short distance, cursor 24 may traverse a small number of characters. If, however, user 3's finger moves a longer distance while being detected by UI device 4, cursor 24 may traverse a larger number of characters. In other examples, the number of characters traversed by cursor 24 as a result of gesture 26 may be based at least in part upon the velocity of user 3's finger during gesture 26. For instance, keyboard module 8 may non-linearly map the cursor speed to the speed of user 3's finger, using an intelligent transfer function that allows for both fine-grained control at slow speeds and faster accelerated movement at high speeds. As one example, slow speeds may include 0-2 feet per second and high speed may be those speeds faster than 2 feet per second. If user 3's finger is traveling fast along the tracking region then the algorithm may automatically switch to a word-level movement pattern, with cursor 24 stopping only at the ends of words, thereby allowing for both faster movement and better editing control (where word endpoints are more likely to be the intended destinations).

In some examples the change in location of cursor 24 within text content may be based on one or more physical simulations. For instance, UI module 6 may associate one or more properties with cursor 24 that indicate simulated density, mass, composition, etc. UI module 6 may define one or more physical simulations that UI module 6 can apply to cursor 24 when a cursor control gesture is input. For instance, a physical simulation may simulate a weight of cursor 24, such that when UI device 4 detects gesture 26, UI module 6 can apply the simulation to virtually “throw” or “shove” cursor 24. In some examples, physical simulations may change based on properties of gesture 26 such as velocity, distance, etc. of the gesture.

In other examples, UI module 6 may define one or more physical simulations to be applied to gesture 26 itself. For instance, a physical simulation may simulate elasticity of a spring, elastics, pillow, etc., such that when user 3 moves his or her finger farther away, in a direction, from the position on UI device 4 at which gesture 26 originated, movement of cursor 24 through the text content may proportionately increase in velocity in the same direction.

In this manner, techniques of this disclosure may improve efficiency and accuracy of text entry and editing by proving a user with cursor controls better suited to maintain the user's focus and providing fine-grained control. In other words, the user can slide his or her finger to move the cursor, without removing his or her focus from the graphical keyboard or obstructing portions of text content. For example, a user may input a cursor control gesture by placing his or her finger on the spacebar key, and sliding to the left to move the cursor leftwards through the text content, and release the finger when he or she is satisfied with the current cursor position. In another example, instead of releasing his or her finger, the user may have moved the cursor too far to the left. The user may simply slide his or her finger back to the right to move the cursor rightwards through the text content. In another example, the user may place his or her finger within the cursor control region, and slide his or her finger to the left or right to start moving the cursor through the text content in that direction. The user may slide his or her finger back to the location at which the cursor control gesture originated to cease moving the cursor.

Techniques of the disclosure may also beneficially use a preexisting area of a graphical keyboard, e.g., the spacebar key, as a cursor control region to receive indications of gestures that move the cursor within a graphical user interface. Consequently, rather than initially displaying a virtual trackpad, which may require additional area of a graphical user interface, techniques of the disclosure can use, for example, preexisting area of a graphical keyboard (e.g., an area associated with at least one key). As shown in subsequent FIGS. of the present disclosure, if the user desires additional control of the cursor, the user can perform one or more gestures to later initiate the display of a virtual trackpad.

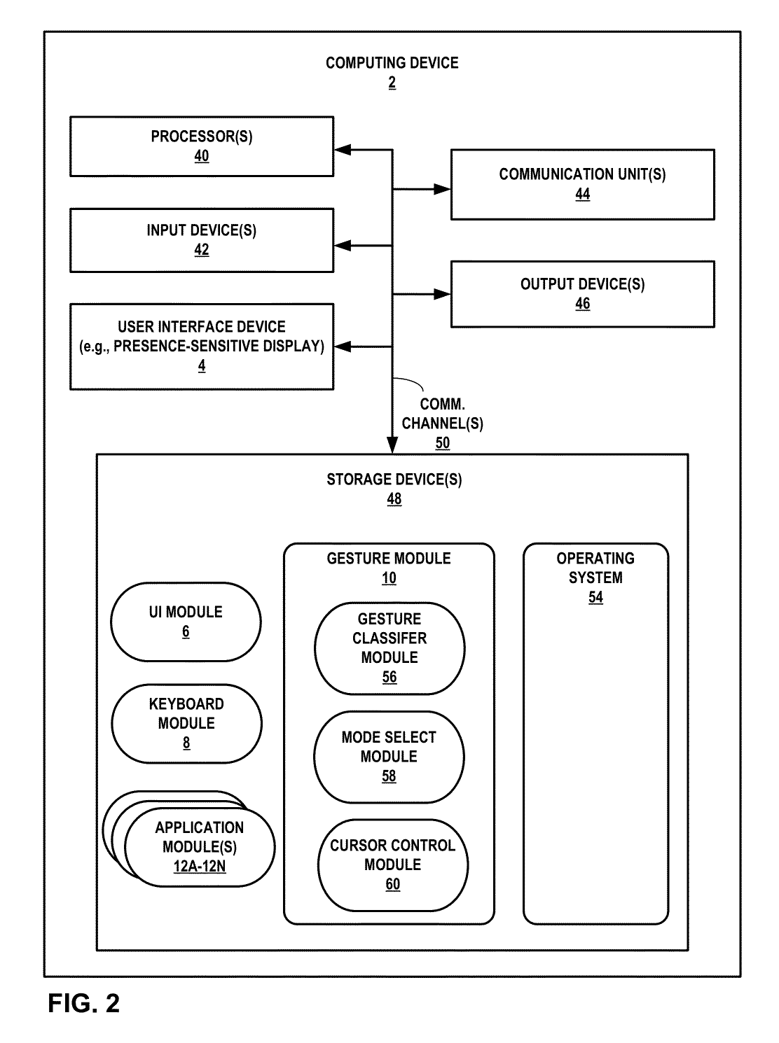

FIG. 2 is a block diagram illustrating further details of one example of a computing device shown in FIG. 1 for providing gesture-based cursor control, in accordance with one or more aspects of the present disclosure. FIG. 2 illustrates only one particular example of computing device 2, and many other examples of computing device 2 may be used in other instances.

As shown in the specific example of FIG. 2, computing device 2 includes one or more processors 40, one or more input devices 42, one or more communication units 44, one or more output devices 46, one or more storage devices 48, and user interface (UI) device 4. Computing device 2, in one example, further includes modules 6, 8, 10, 12 and operating system 54 that are executable by computing device 2. Gesture module 10 may include gesture classifier module 56, mode select module 58, and cursor control module 60. Each of components 40, 42, 44, 46, and 48 may be interconnected (physically, communicatively, and/or operatively) for inter-component communications. As one example in FIG. 2, components 4, 40, 42, 44, 46, and 48 may be coupled by one or more communication channels 50. In some examples, communication channels 50 may include a system bus, network connection, interprocess communication data structure, or any other channel for communicating data. Modules 6, 8, 10, 12, 56, 58, and 60, as well as operating system 54 may also communicate information with one another as well as with other components in computing device 2.

Processors 40, in one example, are configured to implement functionality and/or process instructions for execution within computing device 2. For example, processors 40 may be capable of processing instructions stored in storage device 48. Examples of processors 40 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 48 may be configured to store information within computing device 2 during operation. Storage devices 48, in some examples, are each described as a computer-readable storage medium. In some examples, storage devices 48 are temporary memory, meaning that a primary purpose of storage devices 48 is not long-term storage. Storage devices 48, in some examples, are described as a volatile memory, meaning that storage devices 48 do not maintain stored contents when the computer is turned off. Examples of volatile memories include random access memories (RAM), dynamic random access memories (DRAM), static random access memories (SRAM), and other forms of volatile memories known in the art. In some examples, storage devices 48 are used to store program instructions for execution by processors 40. Storage devices 48, in one example, are used by software or applications running on computing device 2 (e.g., modules 6, 8, 10, 12) to temporarily store information during program execution.

Storage devices 48, in some examples, also include one or more computer-readable storage media. Storage devices 48 may be configured to store larger amounts of information than volatile memory. Storage devices 48 may further be configured for long-term storage of information. In some examples, storage devices 48 include non-volatile storage elements. Examples of such non-volatile storage elements include magnetic hard discs, optical discs, floppy discs, flash memories, or forms of electrically programmable memories (EPROM) or electrically erasable and programmable memories (EEPROM).

Computing device 2, in some examples, also includes one or more communication units 44. Computing device 2, in one example, utilizes communication units 44 to 44 to communicate with external devices via one or more networks, such as one or more wireless networks. Communication units 44 may include a network interface card, such as an Ethernet card, an optical transceiver, a radio frequency transceiver, or any other type of device that can send and receive information. Other examples of such network interfaces may include Bluetooth, 3G and WiFi radio computing devices as well as Universal Serial Bus (USB). In some examples, computing device 2 utilizes communication units 44 to wirelessly communicate with an external device such as other instances of computing device 2 of FIG. 1, or any other computing device.

Computing device 2, in one example, also includes one or more input devices 42. Input devices 42, in some examples, are configured to receive input from a user through tactile, audio, or video feedback. Examples of input devices 42 include a presence-sensitive display, a mouse, a keyboard, a voice responsive system, video camera, microphone or any other type of device for detecting a command from a user. In some examples, a presence-sensitive display includes a touch-sensitive screen.

One or more output devices 46 may also be included in computing device 2. Output devices 46, in some examples, are configured to provide output to a user using tactile, audio, or video stimuli. Output devices 46, in one example, include a presence-sensitive display, a sound card, a video graphics adapter card, or any other type of device for converting a signal into an appropriate form understandable to humans or machines. Additional examples of output devices 46 include a speaker, a cathode ray tube (CRT) monitor, a liquid crystal display (LCD), or any other type of device that can generate intelligible output to a user.

In some examples, UI device 4 may include functionality of input devices 42 and/or output devices 46. In the example of FIG. 2, UI device 4 may be a touch-sensitive screen. In some examples, a presence-sensitive display may detect an object at and/or near the screen of the presence-sensitive display. As one example range, a presence-sensitive display may detect an object, such as a finger or stylus that is within 2 inches or less of the physical screen of the presence-sensitive display. The presence-sensitive display may determine a location (e.g., an (x,y) coordinate) of the presence-sensitive display at which the object was detected. In another example range, a presence-sensitive display may detect an object 6 inches or less from the physical screen of the presence-sensitive display and other exemplary ranges are also possible. The presence-sensitive display may determine the location of the display selected by a user's finger using capacitive, inductive, and/or optical recognition techniques. In some examples, presence-sensitive display provides output to a user using tactile, audio, or video stimuli as described with respect to output device 46.

Computing device 2 may include operating system 54. Operating system 54, in some examples, controls the operation of components of computing device 2. For example, operating system 54, in one example, facilitates the communication of modules 6, 8, 10 and 12 with processors 40, communication unit 44, storage device 48, input device 42, UI device 4, and output device 46. Modules 6, 8, 10, 12 may each include program instructions and/or data that are executable by computing device 2. As one example, UI module 6 may include instructions that cause computing device 2 to perform one or more of the operations and actions described in the present disclosure.

In accordance with techniques of the present disclosure, one of application modules 12 (e.g., application module 12A) may cause UI device 4 to display a graphical user interface (GUI) that includes a graphical keyboard and a text display region having a cursor displayed in a first position, such as cursor 24 as shown in GUI 14 of FIG. 1. In accordance with techniques of this disclosure, user 3 may perform a touch gesture at a location of UI device 4 that displays graphical keyboard 20. UI device 4 may detect the gesture and, in response, UI module 6 may determine whether the gesture is a tap gesture or some other form of gesture, and whether the gesture originated in a cursor control region of graphical keyboard 20. If the performed gesture was a tap gesture and/or did not originate in the cursor control region, UI module 6 may ignore the gesture or perform a different operation, such as send an indication of the gesture to keyboard module 8 for normal keyboard input processing.

If, however, the gesture corresponds to a gesture other than a tap gesture and the gesture originated in the cursor control region, UI module 6 may send an indication of the gesture to gesture module 10. The indication of the gesture may be received by gesture classifier module 56. Gesture classifier module 56 may then determine what type of gesture was inputted. The inputted gesture may, in various examples, constitute a selection of one or more keys (e.g., spacebar key 23 of FIG. 1), a cursor control enlargement gesture, a cursor control gesture, or other gesture. For instance, the gesture may be an attempt by the user to input one or more space characters through a continuing selection of the spacebar. In such examples, gesture classifier module 56 may ignore the gesture or perform a different operation, such as sending an indication of the gesture to keyboard module 8. In other examples, the user may input a cursor control enlargement gesture intended to cause the display of a graphical cursor control interface. If, however, gesture classifier module 56 determines that the inputted gesture is a cursor control gesture, gesture classifier module 56 may communicate with mode select module 58. Additionally, gesture classifier module 56 may, responsive to determining that the inputted gesture is a cursor control gesture, send information to cursor control module 60.

Mode select module 58 may determine whether or not a mode key has been or is currently being selected by user 3. If mode select module 58 determines that the mode key was selected and/or continues to be selected by user 3, mode select module 58 may send an indication of the selection to cursor control module 60.

In response to receiving information from gesture classifier module 56, cursor control module 60 may utilize a cursor movement process to send instructions to UI module 6, causing UI device 4 to output the cursor at a second cursor location within the text display region, such as cursor 24 displayed in GUI 16 of FIG. 1. Cursor control module 60 may receive an indication of a selection of the mode key from mode select module 58. Responsive to receiving the indication, cursor control module 60 may employ a cursor selection process to cause UI device 4 to output text content located between the first and second positions of cursor 24 as being in a selected state. Text content existing in a selected state may allow a user to perform additional operations on the selected text content. For instance, a user may remove all of the selected text content with a single selection of a backspace key. In another example, selected text content may be subject to changes in the format, while that text content not in a selected state may remain unchanged. Selected text content may be outputted by UI module 6 for display differently from non-selected text content in order to signify the selection to a user. Examples of differentiation may include applying style changes to the selected text content such as highlighting, underlining, change of color, change of font, bolding, etc.

In any case, gesture module 10 may cause UI device 4 to display cursor 24 at different locations within text display region 18 in response to receiving inputted gestures. If the mode key was selected and/or remains selected for the duration of the inputted gesture, gesture module 10 may cause UI device 4 to display a portion of text content in a selected state. In some examples gesture module 10 may, in response to receiving a cursor control gesture, cause UI device 4 to display cursor identifier 28. In other examples, gesture module 10 may cause UI device 4 to display other indicators.

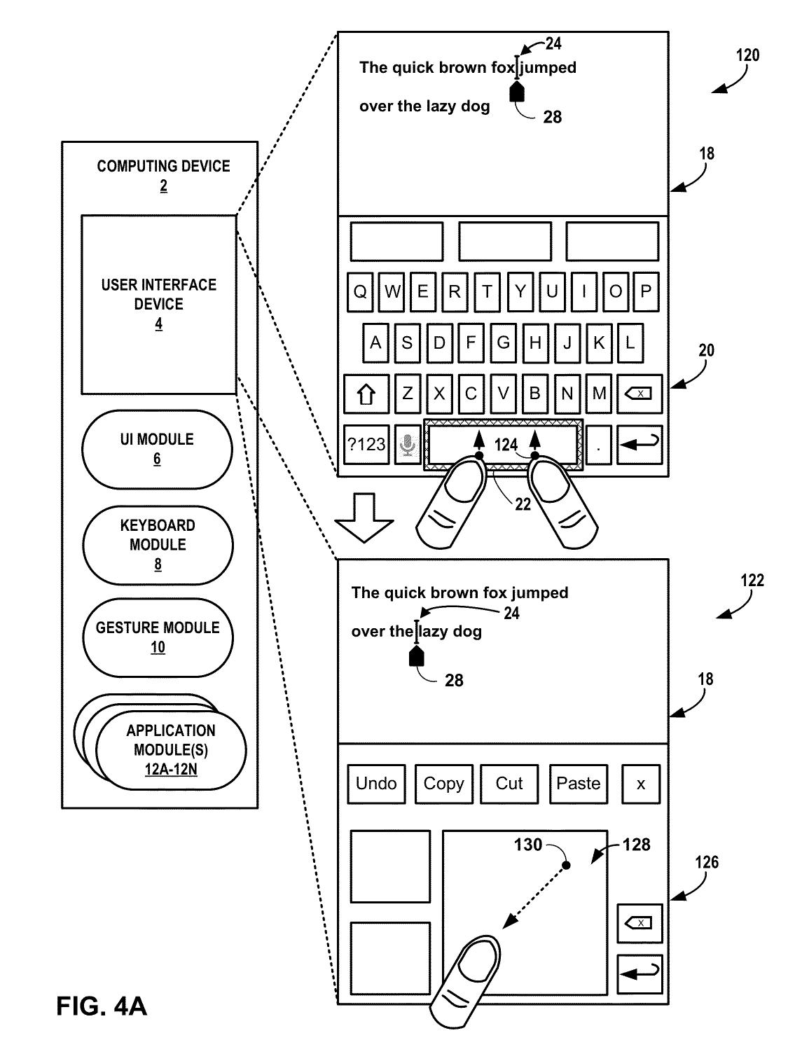

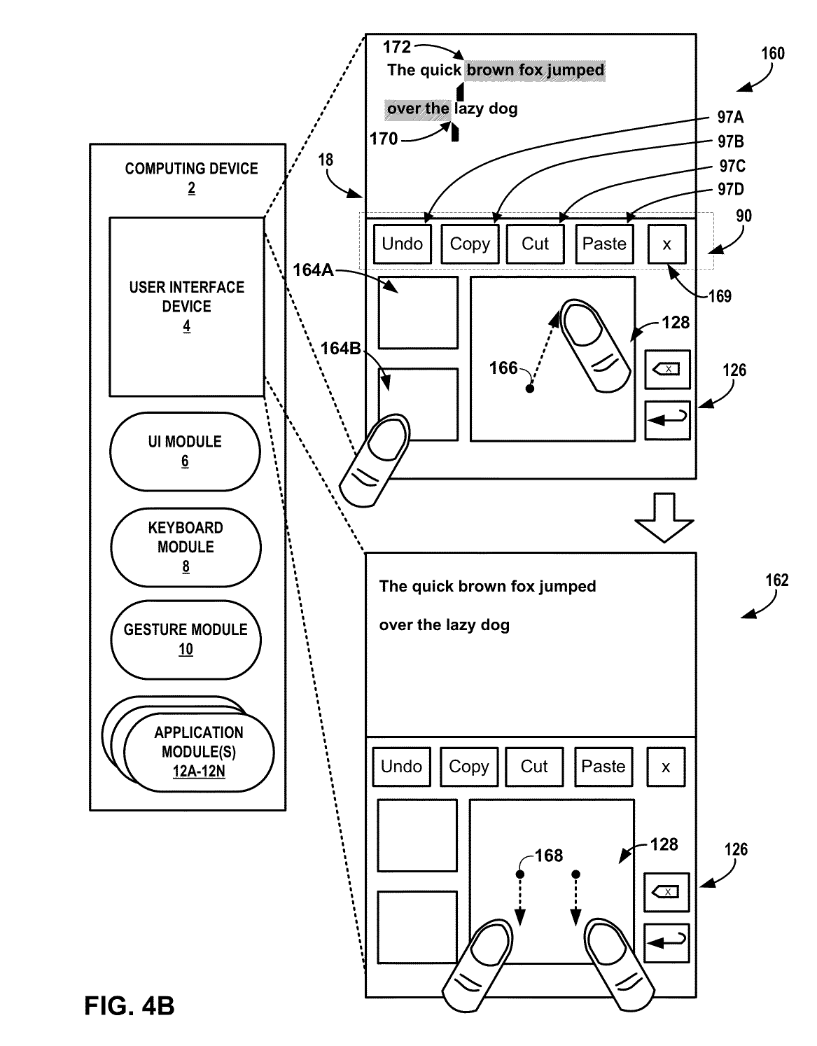

In some examples, e.g., as shown in FIGS. 4A-4B, where gesture classifier module 56 determines that the inputted gesture is a cursor control enlargement gesture, gesture classifier module 56 may send data to UI module 6, causing UI device 4 to display a graphical cursor control interface. The graphical cursor control interface may replace or be overlaid upon a graphical keyboard (e.g., graphical keyboard 20 of GUI 14). In other examples, where gesture classifier module 56 determines that the inputted gesture is a cursor control reduction gesture, gesture classifier module 56 may cause UI device 4 to display graphical keyboard 20. That is, gesture module 10 may allow user 3 to cause UI device 4 to display or not display the graphical cursor control interface by inputting gestures in cursor control region 22.

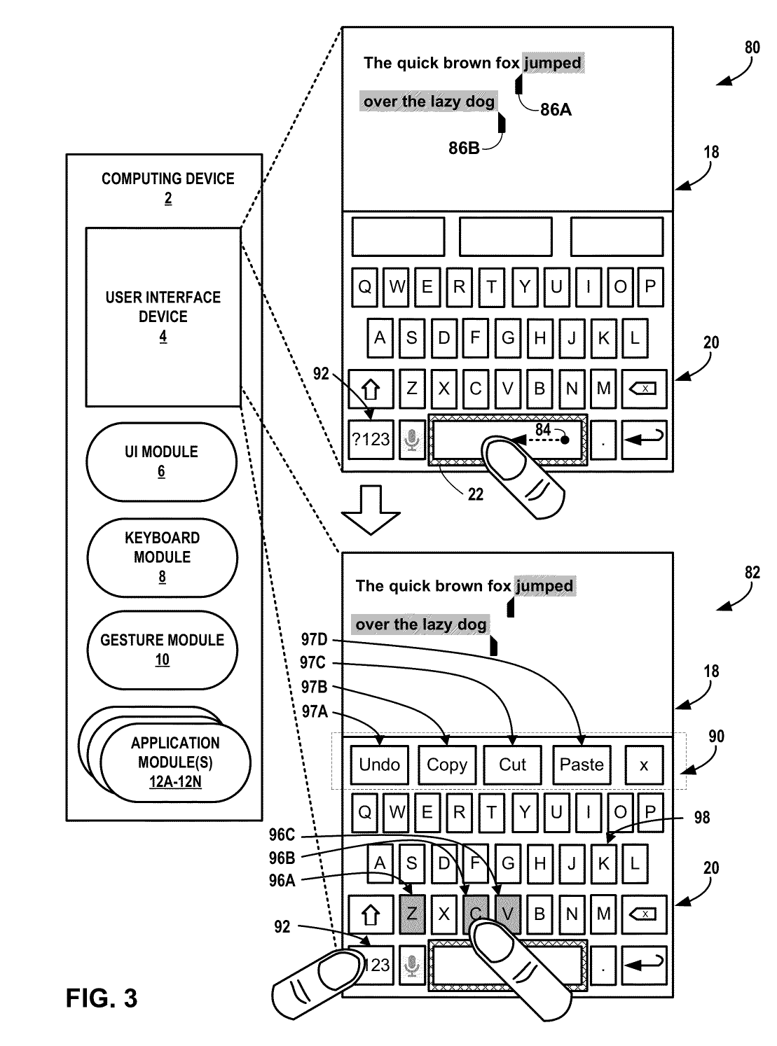

FIG. 3 is a block diagram illustrating an example computing device and a GUI for providing gesture-based cursor control, in accordance with one or more aspects of the present disclosure. As shown in FIG. 3, computing device 2 includes components, such as UI device 4 (which may be a presence-sensitive display), UI module 6, keyboard module 8, gesture module 10, and application modules 12. Components of computing device 2 can include functionality similar to the functionality of such components as described in FIGS. 1 and 2.

In some example techniques, UI module 6 may output for display a modified version of graphical keyboard 20 when a mode key is pressed. For instance, UI module 6 may cause certain keys of graphical keyboard 20 to be displayed in GUI 82 as shortcut keys for text editing (e.g., cut, copy and paste functions), thereby providing for intuitive, speedy text editing capabilities. That is, UI module 6 may display such shortcut keys in a different fashion (e.g., different colors, different fonts, different border widths, etc.) than those keys which are not shortcut keys. Such techniques are further illustrated in FIG. 3.

GUI 80 may initially include text display region 18 and graphical keyboard 20 having cursor control region 22. Graphical keyboard 20 and cursor control region 22 may have functionality as discussed in the context of FIG. 1. Text display region 18 may include the text content, “The quick brown fox jumped over the lazy dog”. In the example of FIG. 3, the cursor may be located at a first cursor location to the right of the “g” character in the word “dog.”

A user (e.g., user 3) may make a selection of a portion of the displayed text content by selecting a mode key, and performing a cursor control gesture to move a cursor and select the portion. In some examples, the mode key may be a dedicated key, newly added to the graphical keyboard. In other examples, the mode key may share functionality with an existing key, such as the shift key or “?123” keyboard switching key 92 (hereinafter “mode key 92). If mode key 92 shares functionality with an existing key, gesture module 10 may determine the intent of the key press based on context (e.g., whether or not the key press is followed by a cursor control gesture). Different types of gestures performed at mode key 92 may result in different functionality. In one example, performing a tap gesture having a short duration (e.g., less than 1 second) may cause UI device 4 to display a different graphical keyboard (such as one with number keys, punctuation keys, etc.), whereas those tap gestures having a long duration (e.g., 1 second or longer) may cause UI device 4 to display shortcut keys for text editing, further described with respect to FIG. 3 below. In other examples, various other gestures, such as double taps, or continuous holding gestures may be used.

In the example of FIG. 3, user 3 may select mode key 92 from graphical keyboard 20. After the selection of mode key 92 and/or while maintaining the selection, user 3 may perform cursor control gesture 84 as shown in GUI 80. Responsive to receiving cursor control gesture 84, UI module 6 may cause UI device 4 to display the text content, “jumped over the lazy dog”, in a selected state. The text content, “jumped over the lazy dog”, may be displayed at UI device 4 as surrounded by highlighting, as seen in GUI 80.

UI module 6 may cause UI device 4 to display selection indicators 86A, 86B (hereinafter “selection indicators 86”). As shown in GUI 80, selection indicator 86A is located at a leading boundary of the selected portion of text content and selection indicator 86B is located at a trailing boundary of the selected portion. In some examples, UI module 6 may not output selection indicators 86 for display. Selection indicators 86 may assist user 3 in delineating the boundaries of selected text content during input of a cursor control gesture (e.g., gesture 84). In some examples, selection indicators 86 may be shapes, objects, images, etc. located at leading and trailing boundaries of selected text content. In other words, selection indicators 86 may be any means of emphasizing or otherwise calling attention to the boundaries of the selected text content.

Referring to GUI 82, a user may wish to perform various functions on a selected portion of text content. For instance, the user may wish to copy the selected portion, cut the selected portion (i.e., remove the selected portion from text display region 18 and temporarily store the selected portion for later use), or paste previously stored text content by replacing the selected portion. The user may press and hold mode key 92 on the displayed graphical keyboard. In response to determining that mode key 92 is pressed and held, UI module 6 may send an indication of the gesture to keyboard module 8. Keyboard module 8 may send data to UI module 6, causing UI device 4 to modify the display of the graphical keyboard such that particular shortcut keys, such as shortcut keys 96A, 96B, and 96C (hereinafter “shortcut keys 96”), are displayed differently from other keys (e.g., key 98). In some examples, keyboard module 8 may cause UI device 4 to modify the displayed graphical keyboard only if a portion of text content is currently selected. That is, to not conflict with normal keyboard operation, shortcut keys 96 may only become activated and/or displayed in a modified manner when there is text selected and mode key 92 is pressed and/or the text selection mode is activated.

In some examples, a user may perform a long press gesture at mode key 92. A long press gesture may, for instance, constitute a tap gesture lasting longer than a certain time threshold, such as one second. Performing a long press of mode key 92 may cause UI device 4 to modify display of graphical keyboard 20 as described above. The user may select one of shortcut keys 96 (e.g., shortcut key 96B) or any other key. Upon receiving this selection, keyboard module 8 may cause UI device 4 to once again display graphical keyboard 20 without indications of the shortcuts. That is, a long press of mode key 92 may temporarily display highlighted or emphasized shortcut keys 96 for selection, and, upon such selection by the user, a normal graphical keyboard is once again displayed.

Shortcut keys 96 may provide access to text editing functions such as cut, copy, paste, or undo. Shortcut keys 96 may be keys from the graphical keyboard which are emphasized or otherwise modified in appearance to draw the user's attention. In the example shown in GUI 82, user 3 may select mode key 92 from the displayed graphical keyboard. Responsive to receiving an indication of the gesture, keyboard module 8 may cause UI device 4 to display shortcut keys 96 differently than other keyboard keys (e.g., key 98) of graphical keyboard 20. Graphical keyboard 20 may, as shown in GUI 82, display shortcut keys 96 (i.e., the “Z”, “C”, and “V” keys, respectively) in a highlighted state, indicating to user 3 the availability of an associated undo, copy, and paste function. That is, while holding mode key 92, graphical keyboard 20 may display shortcut keys 96 differently from other keys, and user 3 may perform a gesture at shortcut key 96A, shortcut key 96B, or shortcut key 96C to perform an undo function, a copy function, or a paste function, respectively.

In some examples, the shortcuts for copy, paste, undo, etc. may be implemented as dedicated buttons within a suggestion region. During regular operation, the suggestion region (e.g., suggestion region 90) may display suggestions or predictions of text input, based upon received input. Suggestions or predictions may include letters, words, phrases, etc. Based on the text content inputted by a user, various components associated with computing device 2 may cause UI device 4 to display predictions of subsequent input within suggestion region 90. The user may then select one or more of the predictions to cause the displayed prediction to be inputted, instead of manually inputting the text content. However, in response to user input, suggestion region 90 may be used to instead display shortcut buttons 97A, 97B, 97C, and 97D (hereinafter “shortcut buttons 97”). That is, suggestion region 90 may save available display space by alternatively displaying predictive text suggestions and shortcut buttons 97 in response to different user inputs.

In some examples, shortcut buttons 97 may replace predictive suggestions in response to the user's continuous selection of mode key 92. In other examples, shortcut buttons 97 may be displayed in suggestion region 90 in response to other input (e.g., a long press on mode key 92) and may require user input in order to be removed. Shortcut buttons 97 may be labeled with their respective functions (i.e., “Undo”, “Copy”, “Cut”, “Paste”). In the example of GUI 82, responsive to receiving a selection of mode key 92, UI device 4 may display shortcut buttons 97 in suggestion region 90.

While holding mode key 92, the user may select one of shortcut keys 96 or shortcut buttons 97 to perform the associated function. As one example, the user may select the “C” key (i.e., shortcut key 96B) to copy the selected portion of text content. In another example, a selection of the “Undo” shortcut button (i.e., shortcut button 97A) may undo the effect of previously entered input, such as erasing inputted text, removing a pasted portion of text, etc. In the example of GUI 82, user 3 may, while holding mode key 92, make a selection of shortcut key 96B. In response to receiving an indication of the selection, keyboard module 8 may copy the selected portion of text, “jumped over the lazy dog”, to a storage device of computing device 2 (e.g., one of storage devices 48, shown in FIG. 2).

FIGS. 4A, 4B are block diagrams illustrating an example computing device and a GUI for providing gesture-based cursor control, in accordance with one or more aspects of the present disclosure. As shown in FIGS. 4A, 4B, computing device 2 includes components, such as UI device 4 (which may be a presence-sensitive display), UI module 6, keyboard module 8, gesture module 10, and application modules 12. Components of computing device 2 can include functionality similar to functionality of such components as described in FIGS. 1 and 2.

In some examples, techniques of the disclosure may enable user 3 to cause the display of an enlarged cursor control region. For instance, user 3 may wish to perform additional cursor control gestures, such as two-dimensional or multi-touch gestures. Techniques of this disclosure may enable user 3 to perform a cursor control enlargement gesture originating in the cursor control region thereby causing a cursor control interface to be displayed.

As shown in FIG. 4A, GUI 120 may initially include text display region 18 and graphical keyboard 20. Text display region 18 may include inputted text content, as well as cursor 24. Graphical keyboard 20 may include cursor control region 22 as shown in GUI 120. Text display region 18, cursor 24, graphical keyboard 20 and cursor control region 22 may have functionality as discussed in the context of FIGS. 1 and 2.

In accordance with techniques of the disclosure, when needed, cursor control region 22 can be expanded to cover more area and support additional types of interactions. That is, user 3 may desire to enlarge the cursor control region, allowing use of a dedicated cursor control interface. Consequently, user 3 may perform a cursor control enlargement gesture originating within cursor control region 22. The cursor control enlargement gesture may be a single or multi-touch gesture, such as sliding up with two fingers. For instance, inputting a cursor control enlargement gesture may require the user to place two input units (e.g., fingers) within cursor control region 22, and move the input units in a substantially vertical (e.g., upward) direction at substantially the same time. In some examples, a substantially vertical direction may be defined by gesture module 10 of computing device 2 as within 10 angular degrees of deviation from the vertical axis. In other examples, a substantially vertical direction may be defined to include gestures within 15, 25, or 40 angular degrees of deviation. That is, a substantially vertical direction can be defined to include various levels of gesture precision. Substantially the same time may be time delimited. In some examples, two movements may be at substantially the same time if they are performed simultaneously. In other examples, the movements may be at substantially the same time if within 100 milliseconds of one another, 1 second of one another, or within some other measure of time. In the example of FIG. 4A, user 3 may perform cursor control enlargement gesture 124 by placing two fingers on cursor control region 22 and sliding both fingers in a substantially upward direction at substantially the same time.

Responsive to a user inputting cursor control enlargement gesture 124, gesture module 10 may cause UI device 4 to display graphical cursor control interface 126. That is, responsive to detecting two input units performing an upward gesture originating at cursor control region 22, gesture module 10 may cause UI device 4 to display graphical cursor control interface 126. Graphical cursor control interface 126 may be displayed over, or in place of graphical keyboard 20 and may include a larger, visually-identifiable cursor control pad (e.g., cursor control pad 128). As shown in FIG. 4A, UI module 6 may output GUI 122 in response to receiving cursor control enlargement gesture 124. GUI 122 may include text display region 18, and graphical cursor control interface 126. Graphical cursor control interface 126 may further include cursor control pad 128. Cursor control pad 128 may be a cursor control region, similar to cursor control region 22 of FIG. 1, allowing user 3 to input cursor control gestures. By providing the dedicated graphical cursor control interface, a larger cursor control region may be used without conflicting with gesture keyboards allowing for gesture-based typing input.

While graphical cursor control interface 126 is displayed, a user may input a cursor control gesture on cursor control pad 128. Cursor control pad 128 may provide functionality for more complex, two-dimensional cursor control gestures. Inputting a two-dimensional cursor control gesture, such as cursor control gesture 130 shown in GUI 122, may enable the user to move a cursor in two directions within text display region 18. That is cursor control pad 128 may allow the user to relocate the cursor vertically as well as horizontally in a concurrent manner, i.e., a single diagonal movement of the cursor. Cursor control pad 128 may include functionality similar to a trackpad, included on some laptop computing devices, allowing the user to lift his or her finger freely to make multiple scrolling movements. In this way, cursor control pad 128 may act as a virtual trackpad allowing for gesture input without taking up valuable keyboard display area. In the example of FIG. 4A, GUI 122 may display graphical cursor control interface 126. User 3 may desire to move cursor 24 from a first cursor location (e.g., to the right of the “x” character of “fox”, as shown in GUI 120), to a second cursor location (e.g., to the left of the “1” character of “lazy”, as shown in GUI 122) within text display region 18. Consequently, user 3 may perform cursor control gesture 130 at cursor control pad 128.

As shown in FIG. 4A, cursor control gesture 130 may include user 3 moving his or her finger in both a downward and leftward direction. Gesture module 10 may receive an indication of cursor control gesture 130, and cause UI device 4 to display cursor 24 at a second cursor location based upon the inputted gesture. That is, gesture module 10 may cause UI device 4 to move cursor 24 down, from the first line of text content to the second line of text content, as well as to the left, from the right of the “x” in “fox”, to the left of the “1” in “lazy”. UI device 4 may output cursor indicator 28 underneath cursor 24, in accordance with the techniques of the present disclosure. Two-dimensional cursor control gestures may increase a user's cursor relocation speed within text content by allowing direct vertical movement, as opposed to requiring the user to scroll horizontally, through each line of text content, in order to move the cursor to the next line of text content.

In response to receiving a cursor control enlargement gesture, UI module 6 may output a graphical cursor control interface for display. A user may wish to select a portion of displayed text content using the graphical cursor control interface. Techniques of the present disclosure may allow a user to perform two-dimensional cursor control gestures at a graphical cursor control interface, thereby selecting a portion of text content.

As shown in GUI 160 of FIG. 4B, a graphical cursor control interface (e.g., graphical cursor control interface 126) may include cursor control pad 128, as well as cursor control buttons 164A and 164B. Graphical cursor control interface 126 and cursor control pad 128 may have functionality as discussed in the context of FIG. 4A. Cursor control buttons 164A and/or 164B may provide functionality similar to mouse buttons of a desktop computing device. In some examples, the behavior of cursor control buttons 164A and 164B may be application specific. In the example of FIG. 4B, user 3 may perform a gesture at cursor control button 164B, thereby selecting cursor control button 164B. User 3 may then perform cursor control gesture 166 at a location of cursor control pad 128. In the course of performing cursor control gesture 166, user 3 may cause the cursor to move from first cursor position 170 at the right of the word “the” in the second line of text content, to second cursor position 172 at the left of the word “brown” in the first line of text content. Responsive to receiving cursor control gesture 166 in conjunction with a selection of cursor control button 164B, gesture module 10 may cause UI device 4 to display the text content, “brown fox jumped over the” (i.e., the text content located between first cursor position 170 and second cursor position 172), in a selected state.

Responsive to receiving a cursor control enlargement gesture (e.g., cursor control gesture 124 of FIG. 4A), gesture module 10 may, in some examples, also cause UI device 4 to display shortcut buttons 97 in suggestion region 90. Shortcut buttons 97 may be labeled with their respective functions (i.e., “Undo”, “Copy”, “Cut”, “Paste”). A selection of one of shortcut buttons 97 may perform the labeled function. For instance, a selection of shortcut button 97B may copy selected text content to a storage device of computing device 2. Suggestion region 90 may also include a dismissal button (e.g., dismissal button 169) providing functionality to dismiss, close, or otherwise cease display of graphical cursor control interface 126. When a user completes cursor control or text selection using the graphical cursor control interface, he or she may select dismissal button 169 to cause UI device 4 to cease displaying graphical cursor control interface 126 and, instead, display a graphical keyboard (e.g., graphical keyboard 20 of FIG. 1).

In some examples, techniques of the disclosure may enable user 3 to perform a gesture to remove cursor control interface 26 from display and return to viewing a graphical keyboard (e.g., graphical keyboard 20 of FIG. 1). For instance, user 3 may desire to input text content using graphical keyboard 20. Techniques of this disclosure may enable user 3 to perform a cursor control reduction gesture originating in the cursor control region and cause a cursor control interface to be removed from GUI 162. That is, the present disclosure may provide one or more mechanisms to switch back to the graphical keyboard. Inputting a cursor control reduction gesture may require the user to place two input units (e.g., fingers) within cursor control pad 128, and move the input units in a substantially vertical (e.g., downward) direction at substantially the same time. In some examples, a substantially vertical direction may be defined by gesture module 10 of computing device 2 as within 10 angular degrees of deviation from the vertical axis. In other examples, a substantially vertical direction may be defined to include gestures within 15, 25, or 40 angular degrees of deviation. That is, a substantially vertical direction can be defined to include various levels of gesture precision. Substantially the same time may be time delimited. In some examples, two movements may be at substantially the same time if they are performed simultaneously. In other examples, the movements may be at substantially the same time if within 100 milliseconds of one another, 1 second of one another, or within some other measure of time. A user can select dismissal button 169 at the top right corner of the graphical cursor control interface, or perform a cursor control reduction gesture.

As shown in the example of FIG. 4B, GUI 162 may initially include graphical cursor control interface 126, having cursor control pad 128. User 3 may perform cursor control reduction gesture 168, consisting of a downward, two-finger swipe, at cursor control pad 128 by inputting two downward sliding gestures in a substantially vertical direction at substantially the same time. Gesture module 10 may receive an indication of cursor control reduction gesture 168, and cause UI device 4 to cease displaying graphical cursor control interface 126. That is, responsive to detecting two input units performing a downward gesture within cursor control pad 128, gesture module 10 may cause UI device 4 to cease displaying graphical cursor control interface 126. In some examples, UI device 4 may display a graphical keyboard (e.g., graphical keyboard 20 of FIG. 1) instead. In this way, when the user completes cursor control or text selection in the enlarged region provided by graphical cursor control interface 126, he or she may switch back to a graphical keyboard to input text content.

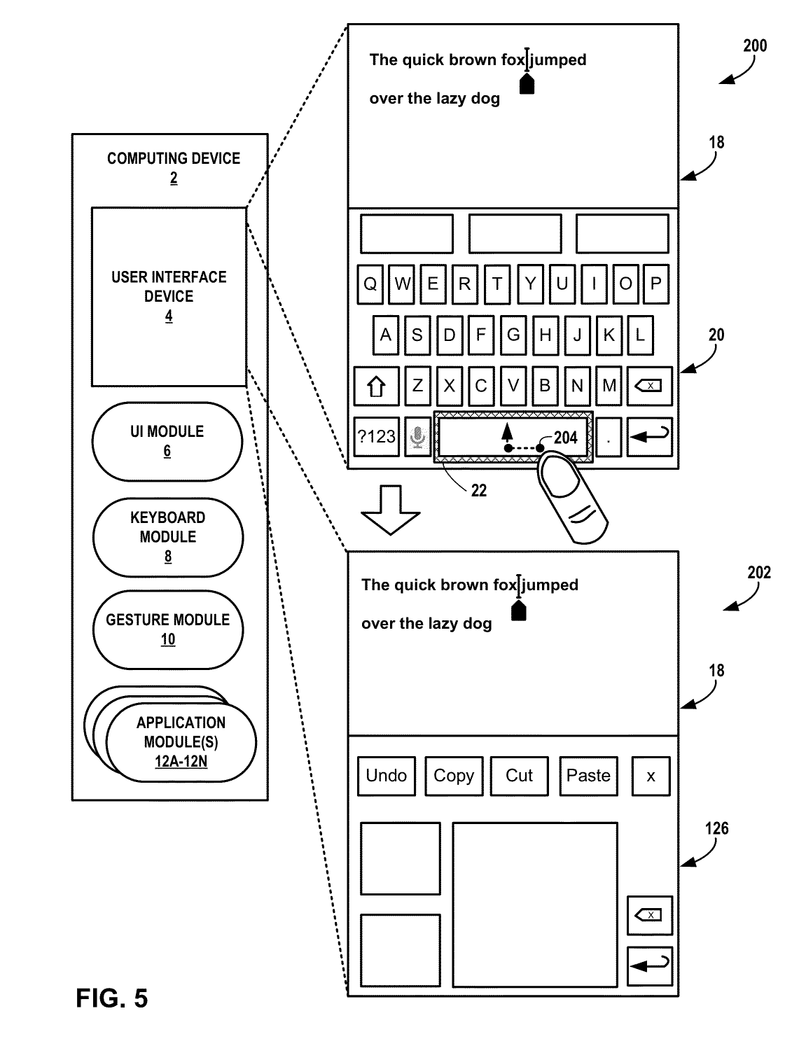

FIG. 5 is a block diagram illustrating an example computing device and a GUI for providing gesture-based cursor control, in accordance with one or more aspects of the present disclosure. As shown in FIG. 5, computing device 2 includes components, such as UI device 4 (which may be a presence-sensitive display), UI module 6, keyboard module 8, gesture module 10, and application modules 12. Components of computing device 2 can include functionality similar to functionality of such components as described in FIGS. 1 and 2.

In some example techniques, the cursor control region of a graphical keyboard may enlarge naturally into the cursor control pad of a graphical cursor control interface as required. That is, UI module 6 may automatically output a graphical cursor control interface for display when a gesture requires it. In some examples, a gesture may cause UI module 6 to automatically output the graphical cursor control interface when the gesture contains motion of an input unit in a substantially vertical direction. For instance, when a user performs movement in such a substantially vertical direction as part of performing a cursor control gesture, this vertical motion may signal that the user wishes the cursor to move upward. In some examples, a substantially vertical direction may be defined by gesture module 10 of computing device 2 as motion in which the input unit travels within 10 angular degrees of deviation from the vertical axis. In other examples, a substantially vertical direction may be defined to include gestures within 15, 25, or 40 angular degrees of deviation. The substantially vertical direction may be variable, based on the level of horizontal movement included in the cursor control gesture. For instance, if the user moves an input unit (e.g., a finger) 4 centimeters to the left, and then 4 millimeters up, this motion may not meet a certain threshold, and no substantially vertical direction may be determined. In contrast, if the user moves his or her finger 1 centimeter to the left and 1 centimeter up, this motion may surpass the threshold, and gesture module 10 may determine that the gesture includes movement in a substantially vertical direction. As another example, vertical movement may be calculated in other ways, such as a simple distance of vertical movement, etc. In response to detecting motion in a substantially vertical direction, above the threshold level, UI module 6 may cause a displayed graphical keyboard to be replaced with a graphical cursor control interface. Such techniques are further illustrated in FIG. 5.

GUI 200 may initially include text display region 18 and graphical keyboard 20 having cursor control region 22. Graphical keyboard 20 and cursor control region 22 may have functionality as discussed in the context of FIG. 1. A user (e.g., user 3) may attempt to perform a cursor control gesture to move a cursor displayed in text display region 18. During performance of the cursor control gesture, user 3 may decide that horizontal scrolling of the cursor is too slow, and attempt to move the cursor in a vertical fashion. Consequently, user 3 may add a vertical movement component to the cursor control gesture by moving his or her finger in a vertical direction during performance of the cursor control gesture. In the example of FIG. 5, user 3 may perform cursor control gesture 204 at cursor control region 22. As seen in FIG. 5, cursor control gesture 204 adds a vertical movement component (i.e., movement in the upward direction) to the left-slide gesture.

In some examples, gesture module 10 may receive an indication of a performed cursor control gesture, and may ignore the vertical component of user 3's inputted gesture. In other examples, gesture module 10 may determine that user 3's action (i.e., the vertical movement of an input unit during performance of the cursor control gesture) necessitates the use of a graphical cursor control interface. Gesture module 10 may cause UI device 4 to output graphical cursor control interface 126 over or instead of graphical keyboard 20. In the example of FIG. 5, responsive to receiving an indication of cursor control gesture 204, gesture module 10 may cause UI device 4 to output graphical cursor control interface 126 as shown in GUI 202.

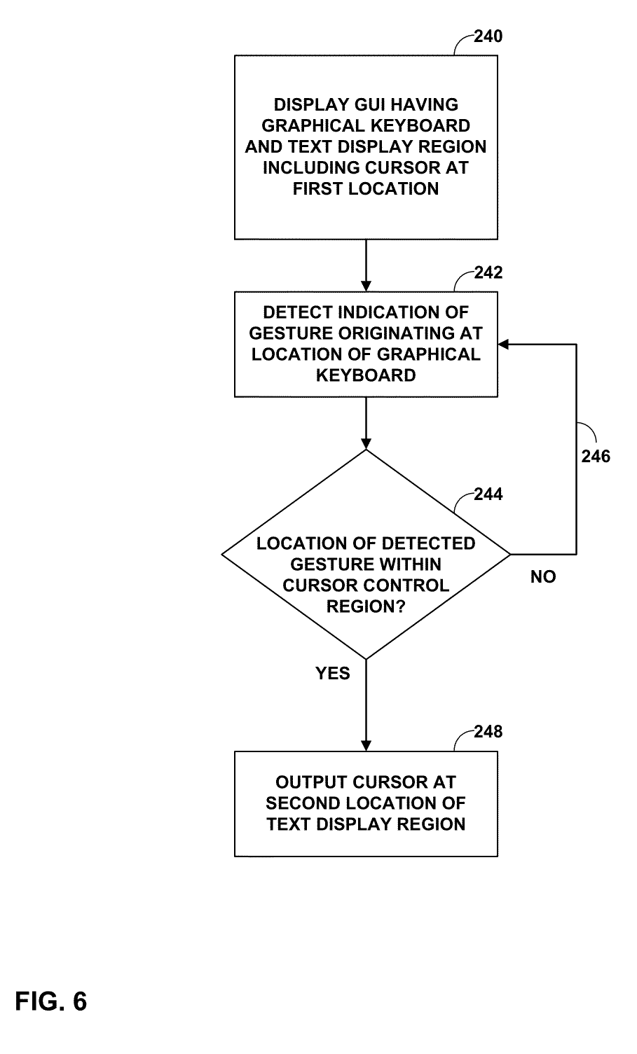

FIG. 6 is a flow diagram illustrating example operations that may be used to provide gesture-based cursor control, in accordance with one or more aspects of the present disclosure. For purposes of illustration only, the example operations are described below within the context of computing device 2, as shown in FIGS. 1 and 2.

In the example of FIG. 6, computing device 2 may initially output a graphical user interface (GUI) for display at a presence-sensitive display, the GUI having a graphical keyboard that includes a cursor control region and a non-cursor control region, wherein the cursor control region does not overlap with the non-cursor control region, and a text display region including a cursor at a first cursor location of the text display region (240). Computing device 2 may subsequently detect an indication of a gesture at the presence-sensitive display, the gesture originating at a location of the graphical keyboard (242). Computing device 2 may determine whether the location of the detected gesture is within the cursor control region of the graphical keyboard (244). If the location of the detected gesture is not within the cursor control region, computing device 2 may ignore the gesture or perform some other action not related to techniques of the present disclosure (246). If the location of the detected gesture is within the cursor control region, computing device 2 may output the cursor at a second cursor location of the text display region (248). In this way, a user may control movement.

In one example, the operations include detecting, by the computing device and at the presence-sensitive display, a selection of a mode key included in the graphical keyboard, and in response to detecting the selection of the mode key, outputting, for display at the presence-sensitive display, a modified graphical keyboard wherein the modified graphical keyboard comprises at least one key displayed with at least one of a highlighted and emphasized effect. In one example, outputting the cursor at the second cursor location of the text display region further comprises outputting in a selected state, for display at the presence-sensitive display and in response to detecting the selection of the mode key, text content located between the first cursor location and the second cursor location.

In one example, the modified graphical keyboard comprises at least one key that is selectable to at least copy, cut, or paste text content, wherein the text content is included in the text display region. In one example, the graphical keyboard comprises a plurality of keys and does not include a virtual trackpad. In one example, wherein the gesture is a first gesture, the operations include detecting, at the presence-sensitive display, a second gesture, determining by the computing device, whether the second gesture is a cursor control enlargement gesture, and in response to determining that the second gesture is the cursor control enlargement gesture, outputting, for display at the presence-sensitive display, a graphical cursor control interface comprising a cursor control pad. In one example, determining whether the second gesture is the cursor control enlargement gesture further comprises detecting, at the presence-sensitive display and by the computing device, two input units at the cursor control region, detecting, at the presence-sensitive display and by the computing device, an upward motion of the two input units at substantially the same time, and determining, by the computing device, whether the motion of both of the two input units is in a substantially vertical direction.

In one example, the graphical cursor control interface further comprises at least one cursor control button. In one example, the operations further include detecting, by the computing device and at the presence-sensitive display, a selection of at least one of the cursor control buttons of the graphical cursor control interface, and wherein outputting the cursor at the second cursor location of the text display region further comprises outputting in a selected state, for display at the presence-sensitive display and in response to detecting the selection of the cursor control button, text content located between the first cursor location and the second cursor location. In one example, the cursor control interface further comprises at least one graphical button that is selectable to copy, cut, or paste text content.

In one example, the operations further include detecting, by the computing device and at the presence-sensitive display, a third gesture, determining, by the computing device, whether the third gesture is a cursor control reduction gesture, and in response to determining that the third gesture is a cursor control reduction gesture, ceasing to output, at the presence-sensitive display, the graphical cursor control interface. In one example, determining whether the third gesture is a cursor control reduction gesture further comprises detecting, at the presence-sensitive display and by the computing device, two input units at the cursor control pad, detecting, at the presence-sensitive display and by the computing device, a downward motion of the two input units at or near the same time, and determining, by the computing device, whether the motion of both of the two input units is in a substantially vertical direction. In one example, the graphical cursor control interface further comprises a dismissal button, and determining whether the third gesture is a cursor control reduction gesture further comprises detecting, at the presence-sensitive display and by the computing device, a selection of the dismissal button.

In one example, the operations further include determining, by the computing device, whether the detected gesture comprises a substantially vertical motion of an input unit detected at the presence-sensitive display, and wherein outputting the cursor at the second cursor location of the text display region further comprises outputting, for display at the presence-sensitive display and in response to determining that the detected gesture includes a vertical movement component, a graphical cursor control interface that includes a cursor control pad. In one example, the graphical keyboard comprises a plurality of keys, and the cursor control region comprises an area of at least one key that is included in the plurality of keys. In one example, the cursor control region comprises an area of a spacebar key included in the plurality of keys.

In one example, the operations further include, responsive to determining that the location of the detected gesture is within the cursor control region, outputting, for display at the presence-sensitive display, a cursor indicator. In one example, the operations further include, responsive to detecting a selection of the mode key, outputting, for display at the presence-sensitive display, selection indicators that indicate a beginning boundary and an ending boundary of selected text content.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
outputting, by a computing device and for display, a graphical user interface that comprises:
a graphical keyboard comprising a plurality of keys, a cursor control region, and a non-cursor control region, wherein the cursor control region comprises an area of at least one key that is included in the plurality of keys and wherein the cursor control region does not overlap with the non-cursor control region, and
a text display region that includes a cursor at a first cursor location of the text display region;
receiving, by the computing device, an indication of a first gesture;
determining, by the computing device, whether the first gesture is a cursor control enlargement gesture;
determining, by the computing device, whether the first gesture originated within the cursor control region of the graphical keyboard;
responsive to determining that the first gesture is the cursor control enlargement gesture and determining that the first gesture originated within the cursor control region of the graphical keyboard, outputting, by the computing device and for display, a cursor control pad that overlays at least a portion of the graphical keyboard;
receiving, by the computing device, an indication of a second gesture, wherein the second gesture originates at a location within the cursor control pad, and wherein the second gesture comprises at least one or a combination of a vertical movement component and a horizontal movement component; and
responsive to receiving the second gesture, outputting, by the computing device and for display, the cursor at a second cursor location of the text display region that is different from the first cursor location, wherein the second cursor location is based at least in part on the at least one or the combination of the vertical movement component and the horizontal movement component.

2. (canceled)

3. The method of claim 1, further comprising receiving, by the computing device, an indication of a selection of a mode key, wherein outputting the cursor at the second cursor location of the text display region further comprises outputting, for display and responsive to receiving the indication of the selection of the mode key, text content located between the first cursor location and the second cursor location in a selected state.

4. (canceled)

5. The method of claim 1, wherein the second gesture comprises a diagonal movement including the combination of the vertical movement component and the horizontal movement component.

6. (canceled)

7. The method of claim 1,
wherein determining whether the first gesture is the cursor control enlargement gesture comprises:
receiving, by the computing device, an indication of two concurrent inputs;
receiving, by the computing device, an indication of input corresponding to motion of both of the two concurrent inputs at substantially the same time; and
determining, by the computing device, whether the motion of both of the two concurrent inputs is in a substantially vertical direction, and
wherein determining whether the first gesture originated within the cursor control region of the graphical keyboard comprises determining whether both of the two concurrent inputs originated within the cursor control region of the graphical keyboard.

8. The method of claim 1, wherein outputting the cursor control pad comprises outputting a graphical cursor control interface, the graphical cursor control interface comprising the cursor control pad and at least one cursor control button.

9. The method of claim 8, further comprising:
receiving, by the computing device, an indication of a selection of the at least one cursor control button,
wherein outputting the cursor at the second cursor location further comprises outputting, for display and responsive to receiving the indication of the selection of the at least one cursor control button, text content located between the first cursor location and the second cursor location in a selected state.

10. The method of claim 8, wherein the at least one cursor control button is selectable to copy, cut, or paste text content.

11. The method of claim 1, further comprising:
receiving, by the computing device, an indication of a third gesture;
determining, by the computing device, whether the third gesture is a cursor control reduction gesture; and
responsive to determining that the third gesture is a cursor control reduction gesture, removing from display, the cursor control pad.

12. The method of claim 11, wherein determining whether the third gesture is a cursor control reduction gesture comprises:
receiving, by the computing device, an indication of two concurrent inputs at the cursor control pad;
receiving, by the computing device, an indication of input corresponding to motion of both of the two concurrent inputs at substantially the same time; and
determining, by the computing device, whether the motion of both of the two concurrent inputs is in a substantially vertical direction.

13. The method of claim 11,
wherein outputting the cursor control pad comprises outputting a graphical cursor control interface, the graphical cursor control interface comprising the cursor control pad and a dismissal button,
wherein determining whether the third gesture is a cursor control reduction gesture comprises receiving, by the computing device, an indication of a selection of the dismissal button, and
wherein removing from display the cursor control pad comprises removing, from display, the graphical cursor control interface.

14. The method of claim 1,
wherein the first gesture comprises a plurality of gesture components,
wherein a first gesture component of the plurality of gesture components comprises a substantially horizontal motion, and
wherein determining whether the first gesture is a cursor control enlargement gesture comprises determining, by the computing device, whether a second gesture component of the plurality of gesture components comprises a substantially vertical motion, the second gesture component being subsequent to the first gesture component.

15. (canceled)

16. The method of claim 1, wherein the cursor control region comprises an area of a spacebar key included in the plurality of keys.

17. The method of claim 1, further comprising, responsive to receiving the second gesture, outputting, for display, a cursor indicator.

18. The method of claim 3, further comprising, responsive to receiving the indication of the selection of the mode key, outputting, for display, selection indicators that indicate a beginning boundary and an ending boundary of selected text content.

19. A non-transitory computer-readable storage medium encoded with instructions that, when executed, cause one or more processors of a computing device to perform operations comprising:
outputting, for display, a graphical user interface that comprises:
a graphical keyboard comprising a plurality of keys, a cursor control region, and a non-cursor control region, wherein the cursor control region comprises an area of at least one key that is included in the plurality of keys and wherein the cursor control region does not overlap with the non-cursor control region, and
a text display region that includes a cursor at a first cursor location of the text display region;
receiving an indication of a first gesture;
determining, by the computing device, whether the first gesture is a cursor control enlargement gesture;
determining, by the computing device, whether the first gesture originated within the cursor control region of the graphical keyboard;
responsive to determining that the first gesture is the cursor control enlargement gesture and determining that the first gesture originated within the cursor control region of the graphical keyboard, outputting, for display, a cursor control pad that overlays at least a portion of the graphical keyboard;
receiving an indication of a second gesture, wherein the second gesture originates at a location within the cursor control pad, and wherein the second gesture comprises at least one or a combination of a vertical movement component and a horizontal movement component; and
responsive to receiving the second gesture, outputting, for display, the cursor at a second cursor location of the text display region that is different from the first cursor location, wherein the second cursor location is based at least in part on the at least one or the combination of the vertical movement component and the horizontal movement component.

20. A computing device, comprising:
one or more processors; and
at least one module operable by the one or more processors to:
output, for display, a graphical user interface that comprises:
a graphical keyboard comprising a plurality of keys, a cursor control region, and a non-cursor control region, wherein the cursor control region comprises an area of at least one key that is included in the plurality of keys and wherein the cursor control region does not overlap with the non-cursor control region, and
a text display region that includes a cursor at a first cursor location of the text display region;
receive an indication of a first gesture;
determine whether the first gesture is a cursor control enlargement gesture;
determine whether the first gesture originated within the cursor control region of the graphical keyboard;
responsive to determining that the first gesture is the cursor control enlargement gesture and determining that the first gesture originated within the cursor control region of the graphical keyboard, output, for display, a cursor control pad that overlays at least a portion of the graphical keyboard;
receive an indication of a second gesture, wherein the second gesture originates at a location within the cursor control pad, and wherein the second gesture comprises at least one or a combination of a vertical movement component and a horizontal movement component; and
responsive to receiving the second gesture, output, for display, the cursor at a second cursor location of the text display region that is different from the first cursor location, wherein the second cursor location is based at least in part on the at least one or the combination of the vertical movement component and the horizontal movement component.

21. The method of claim 1, wherein the cursor control pad does not comprise a plurality of keys.

22. The non-transitory computer-readable storage medium of claim 19,
wherein the first gesture comprises a plurality of gesture components,
wherein a first gesture component of the plurality of gesture components comprises a substantially horizontal motion, and
wherein the instructions that cause the one or more processors of the computing device to determine whether the first gesture is a cursor control enlargement gesture comprise instructions that, when executed, cause the one or more processors of the computing device to perform operations comprising determining, by the computing device, whether a second gesture component of the plurality of gesture components comprises a substantially vertical motion, the second gesture component being subsequent to the first gesture component.

23. The device of claim 20,
wherein outputting the cursor control pad comprises outputting a graphical cursor control interface, the graphical cursor control interface comprising the cursor control pad and at least one cursor control button,
wherein the at least one module is further operable by the one or more processors to receive an indication of a selection of the at least one cursor control button, and
wherein outputting the cursor at the second cursor location further comprises outputting, for display and responsive to receiving the indication of the selection of the at least one cursor control button, text content located between the first cursor location and the second cursor location in a selected state.
